(19) United States
(12) Patent Application Publication
(10) Pub. No.: US 2025/0226907 A1
(43) Pub. Date: Jul. 10, 2025

(54) Method, System, and Computer Program Product for Containerized Optical Network Data Warehouse

(71) Applicant: II-VI Delaware, Inc., Wilmington, DE (US)

(72) Inventors: Yajun Wang, Naperville, DE (US); Richard Riffel, Raymore, MO (US); Kenneth Jay Falta, McMurray, PA (US); Kimon Papakos, Chicago, IL (US)

(21) Appl. No.: 19/008,981

(22) Filed: Jan. 3, 2025

Related U.S. Application Data
(60) Provisional application No. 63/617,959, filed on Jan. 5, 2024.

(51) Int. Cl. H04J 14/02

(52) U.S. Cl. CPC H04J 14/0212; H04J 14/0213

(57) ABSTRACT

Methods for managing data associated with an optical communications network may include receiving data associated with an optical communications network, containerizing the data associated with the optical communications network according to a characteristic of the data to provide a data structure that includes containerized data, and providing access to the data structure for one or more application sessions. Systems and computer program products are also disclosed.

### CROSS REFERENCE TO RELATED APPLICATION

This application claims priority to U.S. Provisional Patent Application No. 63/617,959 filed on Jan. 5, 2024, the disclosure of which is hereby incorporated by reference in its entirety.

### BACKGROUND

### 1. Field

This disclosed subject matter relates generally to fiber-optic communication and, in some non-limiting embodiments, to systems, methods, and computer program products for managing data associated with an optical communications network.

Optical communication (e.g., optical telecommunication) may refer to a method of communication between two locations at a distance apart using light to carry information. An optical communication system may use a transmitter, which encodes a message into an optical signal, a channel, which carries the optical signal to its destination, and a receiver, which reproduces the message from the optical signal that is received by the receiver.

### 2. Technical Considerations

Fiber-optic communication may refer to a form of optical communication that involves transmitting information from one place to another by sending pulses of light (e.g., infrared light) through an optical fiber. The light may be used as a form of carrier wave that is modulated to carry the information. Optical fiber may be preferred over electrical cabling in specific situations, such as when high bandwidth, long distance, and/or immunity to electromagnetic interference is required. Fiber-optic communication can transmit voice, video, and telemetry through local area networks or across long distances.

In some optical communications networks, an optical channel monitor (OCM) device may provide control processing. For example, an OCM device may provide power balancing control processing by continuously taking optical channel power measurement (OCPM) data and determining whether an attenuation level of each wavelength (e.g., each channel) needs to be adjusted within a wavelength selectable switch (WSS). In some situations, to ensure power level accuracy before adjusting the WSS, the OCM device may average OCPM data over a pre-determined period while a control loop process is running continuously. In this way, OCPM data may stay within the control loop process.

However, when an external processing session (e.g., a web session or different client session) needs to access the OCPM data and/or raw spectrum data, the control loop process may need to be interrupted. Such interruption may cause network and/or wavelength service outage. Further, the OCPM data and/or raw spectrum data may not be accessible by different remote nodes (e.g., that operate an external processing session) through automatic methods.

### SUMMARY

Accordingly, it is an object of the presently disclosed subject matter to provide systems, devices, products, and/or methods managing data associated with an optical communications network.

According to non-limiting embodiments or aspects, provided is a system for managing data associated with an optical communications network, comprising: at least one processor configured to: receive data associated with an optical communications network; containerize the data associated with the optical communications network according to a characteristic of the data to provide a data structure that includes containerized data; and provide access to the data structure for one or more application sessions.

According to non-limiting embodiments or aspects, provided is a method for managing data associated with an optical communications network comprising: receiving, with at least one processor, data associated with an optical communications network; containerizing, with at least one processor, the data associated with the optical communications network according to a characteristic of the data to provide a data structure that includes containerized data; and providing, with at least one processor, access to the data structure for one or more application sessions.

According to non-limiting embodiments or aspects, provided is a computer program product managing data associated with an optical communications network, comprising at least one non-transitory computer-readable medium including one or more instructions that, when executed by at least one processor, cause the at least one processor to: receive data associated with an optical communications network; containerize the data associated with the optical communications network according to a characteristic of the data to provide a data structure that includes containerized data; and provide access to the data structure for one or more application sessions; and transmit the containerized data to the one or more application sessions without interrupting a power balancing control loop.

Further non-limiting embodiments or aspects will be set forth in the following numbered clauses:

Clause 1: A system, comprising: at least one processor configured to: receive data associated with an optical communications network; containerize the data associated with the optical communications network according to a characteristic of the data to provide a data structure that includes containerized data; and provide access to the data structure for one or more application sessions.

Clause 2: The system of clause 1, wherein the at least one processor is further configured to: provide a power balancing command to a wavelength selective switch (WSS).

Clause 3: The system of clause 1, wherein the at least one processor is further configured to: store the data structure in an on-board memory location of an optical channel monitoring (OCM) device.

Clause 4: The system of clause 1, wherein, when containerizing the data associated with the optical communications network according to a characteristic of the data, the at least one processor is configured to: determine a first tap point associated with a first portion of the data associated with the optical communications network; determine a second tap point associated with a second portion of the data associated with the optical communications network; store the first portion of the data associated with the optical communications network in a first location of the data structure associated with the first tap point; and store the second portion of the data associated with the optical communications network in a second location of the data structure associated with the second tap point.

Clause 5: The system of clause 1, wherein, when providing access to the data structure for the one or more application sessions, the at least one processor is configured to: provide access to the data structure for the one or more application sessions via an Ethernet Bus.

Clause 6: The system of clause 1, wherein, when receiving the data associated with the optical communications network, the at least one processor is configured to: receive the data associated with the optical communications network through at least one of the following: an optical supervisory channel (OSC); a remote management channel (RMC); or any combination thereof.

Clause 7: The system of clause 1, wherein the at least one processor is further configured to: transmit the containerized data to the one or more application sessions without interrupting a power balancing control loop.

Clause 8: A method, comprising: receiving, with at least one processor, data associated with an optical communications network; containerizing, with at least one processor, the data associated with the optical communications network according to a characteristic of the data to provide a data structure that includes containerized data; and providing, with at least one processor, access to the data structure for one or more application sessions.

Clause 9: The method of clause 8, further comprising: providing a power balancing command to a wavelength selective switch (WSS).

Clause 10: The method of clause 8, further comprising: storing the data structure in an on-board memory location of an optical channel monitoring (OCM) device.

Clause 11: The method of clause 8, wherein containerizing the data associated with the optical communications network according to a characteristic of the data comprises: determining a first tap point associated with a first portion of the data associated with the optical communications network; determining a second tap point associated with a second portion of the data associated with the optical communications network; storing the first portion of the data associated with the optical communications network in a first location of the data structure associated with the first tap point; and storing the second portion of the data associated with the optical communications network in a second location of the data structure associated with the second tap point.

Clause 12: The method of clause 8, wherein providing access to the data structure for the one or more application sessions comprises: providing access to the data structure for the one or more application sessions via an Ethernet Bus.

Clause 13: The method of clause 8, wherein receiving the data associated with the optical communications network comprises: receiving the data associated with the optical communications network through at least one of the following: an optical supervisory channel (OSC); a remote management channel (RMC); or any combination thereof.

Clause 14: The method of clause 8, further comprising: transmitting the containerized data to the one or more application sessions without interrupting a power balancing control loop.

Clause 15: A computer program product, comprising at least one non-transitory computer-readable medium including one or more instructions that, when executed by at least one processor, cause the at least one processor to: receive data associated with an optical communications network; containerize the data associated with the optical communications network according to a characteristic of the data to provide a data structure that includes containerized data; and provide access to the data structure for one or more application sessions; and transmit the containerized data to the one or more application sessions without interrupting a power balancing control loop.

Clause 16: The computer program product of clause 15, wherein the one or more instructions further cause the at least one processor to: provide a power balancing command to a wavelength selective switch (WSS).

Clause 17: The computer program product of clause 15, wherein the one or more instructions further cause the at least one processor to: store the data structure in an on-board memory location of an optical channel monitoring (OCM) device.

Clause 18: The computer program product of clause 15, wherein, the one or more instructions that cause the at least one processor to containerize the data associated with the optical communications network according to a characteristic of the data, cause the at least one processor to: determine a first tap point associated with a first portion of the data associated with the optical communications network; determine a second tap point associated with a second portion of the data associated with the optical communications network; store the first portion of the data associated with the optical communications network in a first location of the data structure associated with the first tap point; and store the second portion of the data associated with the optical communications network in a second location of the data structure associated with the second tap point.

Clause 19: The computer program product of clause 15, wherein, the one or more instructions that cause the at least one processor to provide access to the data structure for the one or more application sessions, cause the at least one processor to: provide access to the data structure for the one or more application sessions via an Ethernet Bus.

Clause 20: The computer program product of clause 15, wherein, the one or more instructions that cause the at least one processor to receive the data associated with the optical communications network, cause the at least one processor to: receive the data associated with the optical communications network through at least one of the following: an optical supervisory channel (OSC); a remote management channel (RMC); or any combination thereof.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular forms of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a diagram of a non-limiting embodiment of an environment in which systems, devices, products, and/or methods, described herein, may be implemented, according to the presently disclosed subject matter;

FIG. 2 is a diagram of a non-limiting embodiment of components of one or more devices of FIG. 1;

FIG. 3 is a flowchart of a non-limiting embodiment of a process for managing data associated with an optical communications network, according to the presently disclosed subject matter;

FIGS. 4A and 4B are schematic diagrams of an exemplary implementation of a Reconfigurable Optical Add-Drop Multiplexer (ROADM) node and a data management system, according to the presently disclosed subject matter; and

FIG. 5 is a schematic diagram of an exemplary implementation of a network of ROADM nodes, according to the presently disclosed subject matter.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments of the disclosed subject matter. Hence, specific dimensions and other physical characteristics related to the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments of the disclosed subject matter include methods, systems, and/or computer program products for managing data associated with an optical communications network. In some non-limiting embodiments, the disclosed subject matter provides a method that includes receiving data associated with an optical communications network, containerizing the data associated with the optical communications network according to a characteristic of the data to provide a data structure that includes containerized data, and providing, with at least one processor, access to the data structure for one or more application sessions.

In some non-limiting embodiments, the method may further include providing a power balancing command to a wavelength selective switch (WSS). In some non-limiting embodiments, the method may further include storing the data structure in an on-board memory location of an optical channel monitoring device.

In some non-limiting embodiments, containerizing the data associated with the optical communications network according to a characteristic of the data may include determining a first tap point associated with a first portion of the data associated with the optical communications network, determining a second tap point associated with a second portion of the data associated with the optical communications network, storing the first portion of the data associated with the optical communications network in a first location of the data structure associated with the first tap point, and/or storing the second portion of the data associated with the optical communications network in a second location of the data structure associated with the second tap point.

In some non-limiting embodiments, providing access to the data structure for one or more application sessions includes providing access to the data structure for the one or more application sessions via an Ethernet Bus. In some non-limiting embodiments, receiving the data associated with the optical communications network includes receiving the data associated with the optical communications network through at least one of the following an optical supervisory channel (OSC), a remote management channel (RMC), or any combination thereof. In some non-limiting embodiments, the method may further include transmitting the containerized data to the one or more application sessions without interrupting a power balancing control loop.

In this way, the disclosed subject matter provides for a data structure that allows an external processing session to readily access data (e.g., OCPM data and/or raw spectrum data that has been containerized), without interrupting a control loop process. Further, the data structure may be readily accessible via external sessions (e.g., external sessions operated by a remote device) through automatic methods based on the containerized format of the data.

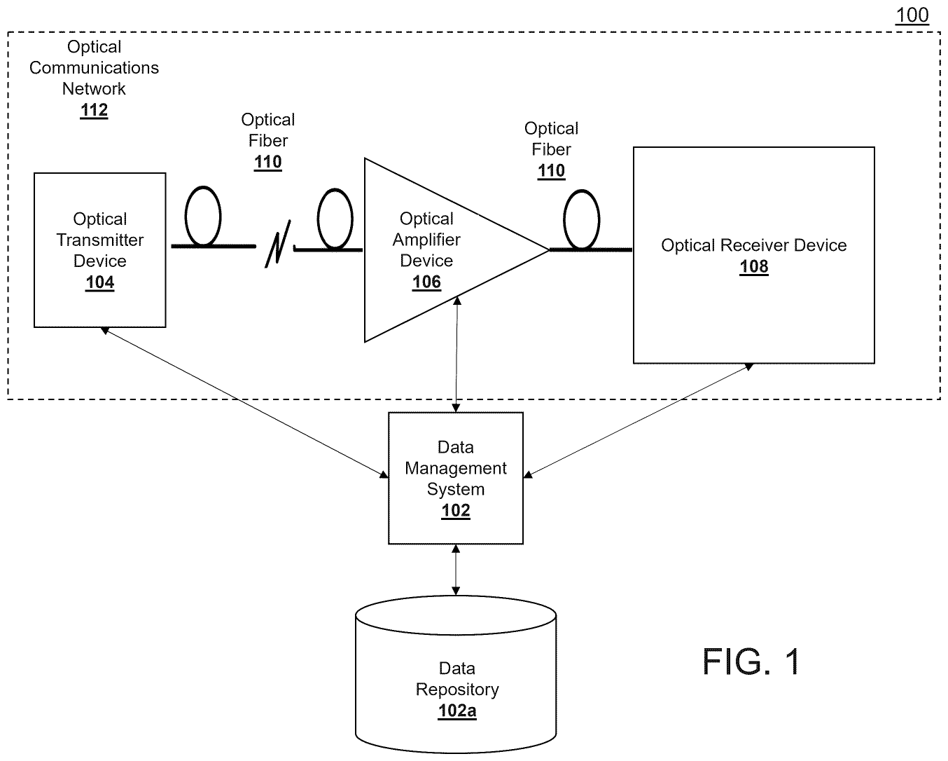

Referring now to FIG. 1, FIG. 1 is a diagram of an example environment 100 in which systems, devices, products, and/or methods, described herein, may be implemented. As shown in FIG. 1, environment 100 may include data management system 102, data repository 102a, optical transmitter device 104, optical amplifier device 106, and optical receiver device 108. Optical transmitter device 104, optical amplifier device 106, and optical receiver device 108 may be connected via optical fiber 110 to form optical communications network 112. In some non-limiting embodiments, data management system 102, optical transmitter device 104, optical amplifier device 106, and optical receiver device 108 may interconnect (e.g., establish a connection to communicate) via wired connections, wireless connections, or a combination of wired and wireless connections. In some non-limiting embodiments, optical communications network 112 may include a Dense Wavelength Division Multiplexing (DWDM) optical network.

Data management system 102 may include one or more devices configured to communicate with data repository 102a, optical transmitter device 104, optical amplifier device 106, and/or optical receiver device 108 and to monitor and control operation of components of optical communications network 112. For example, data management system 102 may include a circuit, a controller, a computing device (e.g., a server, a group of servers, etc.), and/or other like devices. In some non-limiting embodiments, data management system 102 may be in communication with a data storage device (e.g., data repository 102a), which may be local or remote to data management system 102. In some non-limiting embodiments, data management system 102 may be capable of receiving information from, storing information in, transmitting information to, and/or searching information stored in the data storage device. In some non-limiting embodiments, data management system 102 may include, be a part of (e.g., may be a component of, may be onboard, etc.), and/or be in communication with a Reconfigurable Optical Add-Drop Multiplexer (ROADM) node. A ROADM node may include a device that allows dynamic and/or remote configuration of optical channels in optical communications network 112. In one example, the ROADM node may enable the routing, adding, and/or dropping of wavelengths (e.g., in the form of light signals) without the need to convert the wavelengths to electrical signals and without the need for manual intervention, which may enhance network flexibility, scalability, and/or efficiency. Additionally or alternatively, data management system 102 may include, be a part of (e.g., may be a component of), and/or be in communication with an optical channel monitor (OCM) (e.g., a fast OCM, an OCM sensing device, etc.) and/or other components of an optical communications network.

Data repository 102a may include one or more devices configured to communicate with data management system 102, optical transmitter device 104, optical amplifier device 106, and/or optical receiver device 108. For example, data repository 102a may include a circuit, a controller, a computing device (e.g., a server, a group of servers, etc.), and/or other like devices. In some non-limiting embodiments, data repository 102a may be a component of data management system 102.

Optical transmitter device 104 may include one or more devices configured to transmit an optical signal (e.g., use an electrical signal to modulate the power of a light source) on an optical communications network. For example, optical transmitter device 104 may include an optical transmitter, an optical transceiver (e.g., an optical and electrical transceiver), and/or other like devices. Additionally or alternatively, data management system 102 may include a semiconductor device, such as a photodiode (e.g., a light-sensitive semiconductor diode), a light-emitting diode (LED), a laser diode, and/or the like. In some non-limiting embodiments, optical transmitter device 104 may include one or more devices configured to communicate with data management system 102.

Optical amplifier device 106 may include one or more devices configured to amplify (e.g., amplify directly, without conversion to an electrical signal) an optical signal on an optical communications network. For example, optical amplifier device 106 may include an optical amplifier (e.g., an erbium-doped fiber amplifier (EDFA)), a repeater (e.g., an optical repeater, an optoelectronic repeater, etc.), and/or other like devices. In some non-limiting embodiments, optical amplifier device 106 may include one or more devices configured to communicate with data management system 102.

Optical receiver device 108 may include one or more devices configured to receive an optical signal in optical communications network 112. For example, optical receiver device 108 may include an optical receiver (e.g., a coherent optical receiver), a photodetector, and/or other like devices. In some non-limiting embodiments, optical receiver device 108 may include one or more devices configured to communicate with data management system 102.

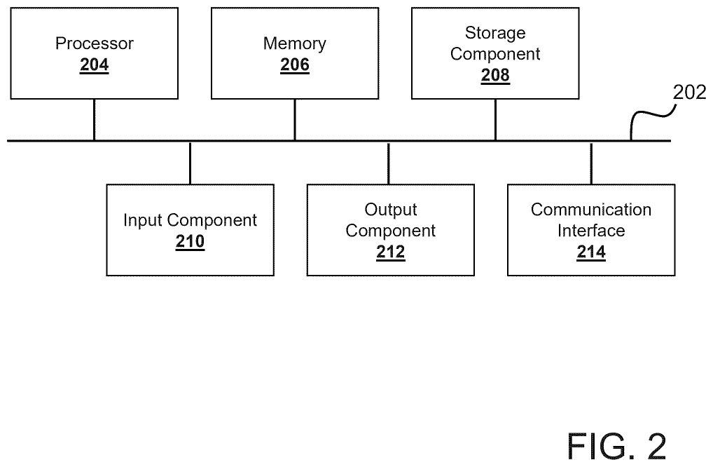

Referring now to FIG. 2, FIG. 2 is a diagram of example components of a device 200. Device 200 may correspond to data management system 102 (e.g., one or more components of data management system 102), data repository 102a, optical transmitter device 104, optical amplifier device 106, optical receiver device 108, optical node 504, and/or control system 506. In some non-limiting embodiments, data management system 102, data repository 102a, optical transmitter device 104, optical amplifier device 106, optical receiver device 108, optical node 504, and/or control system 506 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), a device configured to implement logic functions, etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

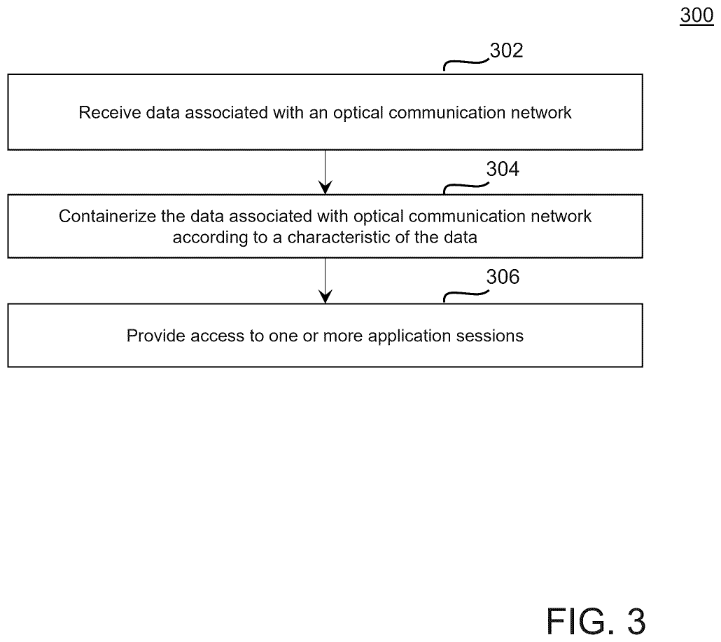

Referring now to FIG. 3, FIG. 3 is a flowchart of a non-limiting embodiment of a process 300 for managing data associated with an optical communications network. In some non-limiting embodiments, one or more of the steps of process 300 may be performed (e.g., completely, partially, etc.) by data management system 102 (e.g., one or more devices of data management system 102). In some non-limiting embodiments, one or more of the steps of process 300 may be performed (e.g., completely, partially, etc.) by another device or a group of devices separate from or including data management system 102, such as data repository 102a, optical transmitter device 104, optical amplifier device 106, optical receiver device 108, optical node 504, and/or control system 506.

As shown in FIG. 3, at step 302, process 300 includes receiving data associated with an optical communication network. For example, data management system 102 may receive data associated with an optical communications network (e.g., optical communications network 112). In some non-limiting embodiments, data management system 102 may receive the data from one or more devices and/or systems of the optical communications network. In some non-limiting embodiments, the data may include data associated with optical channel power measurement (OCPM) and/or raw spectrum data (e.g., raw data associated with a spectrum of light). Additionally or alternatively, the data may include local performance monitoring data, such as optical time domain reflectometer (OTDR) data, data associated with pump drive current time series, data associated with input and/or output EDFA gain stage photodiode power, data associated with photodiode optical telemetry (e.g., data associated with an optical supervisory channel (OSC), OTDR input data, data associated with interstage optical power), transceiver optical performance telemetry data, and/or data associated with optical element hardware and/or software configuration and/or set points.

In some non-limiting embodiments, data management system 102 may receive the data associated with the optical communications network through at least one of an OSC, a remote management channel (RMC), or any combination thereof.

As shown in FIG. 3, at step 304, process 300 includes containerizing the data associated with optical communication network, according to a characteristic of the data. For example, data management system 102 may containerize the data associated with the optical communication network, according to a characteristic of the data to provide a data structure that includes containerized data. In some non-limiting embodiments, a characteristic of the data may include a tap point associated with the data, a channel associated with the data, an output classification of the data with regard to an optical channel monitor, and/or the like. In some non-limiting embodiments, data management system 102 may containerize the data associated with the optical communication network by storing a portion of the data in a container (e.g., a data structure, such as a specific location of a data structure) according to (e.g., mapped to) a characteristic of the data.

In one example, data management system 102 may determine a first tap point associated with a first portion of the data associated with the optical communications network and determine a second tap point associated with a second portion of the data associated with the optical communications network. In such an example, data management system 102 may store the first portion of the data associated with the optical communications network in a first location (e.g., a first container) of the data structure associated with the first tap point and store the second portion of the data associated with the optical communications network in a second location (e.g., a second container) of the data structure associated with the second tap point. In some non-limiting embodiments, data management system 102 may store the data structure in an on-board memory location, such as in an on-board memory location of an OCM device.

As shown in FIG. 3, at step 306, process 300 includes providing access to one or more application sessions. For example, data management system 102 may provide access to the data structure that includes the containerized data for one or more application (e.g., software application) sessions. In some non-limiting embodiments, the one or more application sessions may include an external session, such as a web access session, an external data processing session, such as a client session, a streaming session, such as a streaming session to a software-defined networking (SDN) controller or a network management system (NMS) controller, a local craft session, and/or a session associated with system power monitoring (PM).

In some non-limiting embodiments, data management system 102 may provide access to the data structure for the one or more application sessions via an Ethernet bus. In some non-limiting embodiments, data management system 102 may transmit (e.g., in response to a request) containerized data to the one or more application sessions without interrupting a power balancing control loop. In some non-limiting embodiments, data management system 102 may provide a power balancing command to a wavelength selective switch (WSS). For example, data management system 102 may provide the power balancing command to the WSS as part of the power balancing control loop.

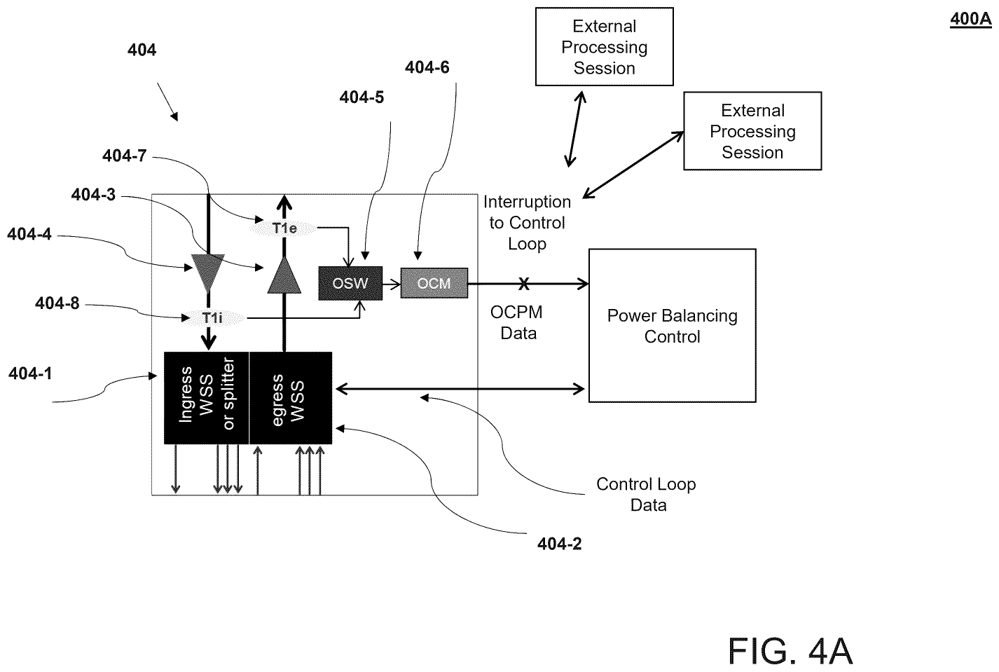

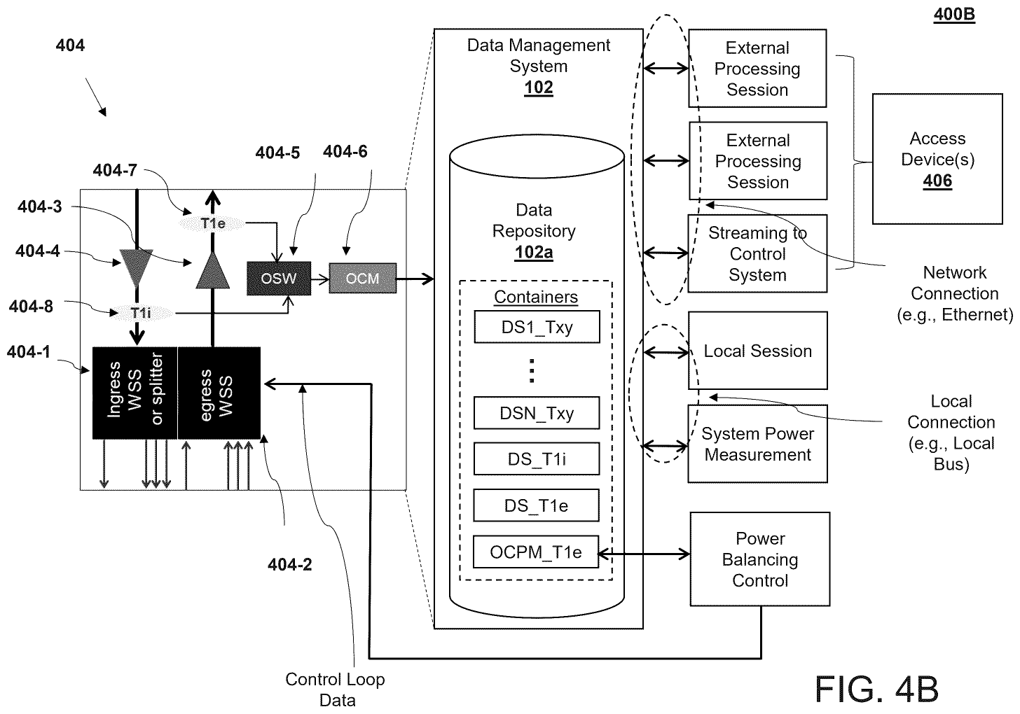

Referring now to FIGS. 4A and 4B, FIGS. 4A and 4B are diagrams of an exemplary implementation 400A and 400B of a system and/or method for managing data associated with an optical communications network, according to non-limiting embodiments of the present disclosure.

As shown in FIGS. 4A and 4B, ROADM node 404 may include WSS 404-1, WSS 404-2, EDFA 404-3, EDFA 404-4, OSW 404-5, and OCM 404-6. As further shown in FIGS. 4A and 4B, the components of ROADM node 404 may include WSS 404-1 and WSS 404-2. In some non-limiting embodiments, WSS 404-1 may include a WSS that is configured on a receive path of ROADM node 404. In some non-limiting embodiments, WSS 404-2 may include a WSS that is configured on a transmit path of ROADM node 404. As further shown in FIGS. 4A and 4B, ROADM node 404 may include OSW 404-5 and OCM 404-6. As further shown in FIGS. 4A and 4B, ROADM node 404 may include a plurality of tap points, such as tap point 1e 404-7 (shown as “T1e”) and tap point 1i 404-8 (shown as “T1i”). As further shown in FIG. 4A, ROADM node 404 may be in communication with a power balancing control system.

In some non-limiting embodiments, OCM 404-6 may provide power balancing control processing for ROADM node 404 by continuously receiving OCPM data and/or raw spectrum data and providing the OCPM data and/or raw spectrum data to a power balancing control system to determine whether an attenuation level of each wavelength of light (e.g., each channel) needs to be adjusted within WSS 404-1 and/or WSS 404-2. In some situations, to ensure power level accuracy before adjusting WSS 404-1 and/or WSS 404-2, OCM 404-6 may perform a data processing procedure on the OCPM data (e.g., calculation of an average of OCPM data over a pre-determined period) while a control loop process is running continuously. In this way, the OCPM data may stay within the control loop process, and interruptions to the control loop process and the power balancing control system may be avoided.

However, when one or more external processing sessions (e.g., a web session, a client session, etc.) may seek to access the OCPM data and/or raw spectrum data, the control loop process may need to be interrupted and such an interruption may cause network and/or wavelength service outages. Further, during operation of ROADM node 404, the OCPM data and/or raw spectrum data may not be accessible by different remote nodes (e.g., that operate an external processing session) through automatic methods. This may be due to the nature of limitations of available data paths (e.g., channels) and/or available bandwidth of an optical network.

As shown in FIG. 4B, as compared to FIG. 4A, ROADM node 404 includes data management system 102. In some non-limiting embodiments, ROADM node 404 may be a separate component that is connected (e.g., communicatively connected) to data management system 102. In some non-limiting embodiments, data management system 102 may be configured to receive data associated with an optical communications network from OCM 404-6 of ROADM node 404. In one example, data management system 102 may be configured to receive the data in the form of one or more data streams (e.g., one or more real-time data streams). In some non-limiting embodiments, the data associated with the optical communications network may include OCM data and/or OCPM data. Additionally or alternatively, the data associated with the optical communications network may include OTDR or other local performance monitoring data, such as pump drive current time series data, Input/Output EDFA gain stage photodiode power data, photodiode optical telemetry data (e.g., OSC channel data, OTDR input, Interstage optical power data, etc.), transceiver optical performance telemetry data, optical element hardware data, software configuration data, and/or setpoint data.

In some non-limiting embodiments, OCM data received from OCM 404-6 of ROADM node 404 may include comprehensive spectral information about an optical signal received and/or transmitted by ROADM node 404, which may include performance metrics including, but not limited to, performance metrics associated with a power level of the optical signal to enable detailed analysis of channel quality. In some non-limiting embodiments, the OCM data may include data associated with a power level of a channel (e.g., data associated with power of individual channels within a monitored spectrum), data associated with a metric of signal quality (e.g., data associated with optical signal-to-noise ratio (OSNR), data associated with spectral shape, such as data associated with integrity of a signal, etc.), data associated with a location of each optical channel on a spectrum of wavelength, and data associated with a spectral analysis of an optical spectrum (e.g., data associated with one or more active channels, such as a number of active channels and respective spacing of active channels, channel noise, and/or interference of a channel, data associated).

In some non-limiting embodiments, the OCPM data received from ROADM node 404 may include data associated with measurements of power levels for each optical channel, which may be more limited in scope as compared to OCM data and may be focused primarily on power monitoring. Additionally or alternatively, the OCPM data may include one or more aggregated metrics of data associated with measurements of power levels.

In some non-limiting embodiments, data management system 102 may use the OCM data and/or the OCPM data for performance monitoring to ensure power levels remain within operational thresholds, health monitoring of an optical network, fault detection of the optical network, and/or optimization in a DWDM system.

As further shown in FIG. 4B, data management system 102 may include data repository 102a, which may include a plurality of containers for storing the data associated with the optical communications network, such as OCM data (e.g., real-time OCM data) and/or OCPM data (e.g., real-time OCPM data), received from ROADM node 404. Each container may be mapped to the one or more components of ROADM node 404. For example, each container may be mapped to a type of data provided by each of the one or more components of ROADM node 404. In some non-limiting embodiments, data management system 102 may containerize the data associated with the optical communications network according to a characteristic of the data to provide a data structure (e.g., a database) of data repository 102a that includes containerized data (e.g., the data associated with the optical communications network that has been separated according to the plurality of containers). In some non-limiting embodiments, a characteristic of the data may include a characteristic of one or more components of ROADM node 404. In some non-limiting embodiments, each container may be mapped to the one or more components of ROADM node 404 (e.g., mapped to a type of data provided by the one or more components of ROADM node 404). In some non-limiting embodiments, data management system 102 may store a data structure that includes the containerized data in an on-board memory location (e.g., a cache memory), such as in an on-board memory location of OCM 404-6 or other device. As shown in FIG. 4B, the plurality of containers may include containers that include specific data (e.g., OCM data OCPM data, raw spectrum data, etc., included in containers labeled DS1_Txy through DSN_Txy), a container that includes data regarding tap point T1i (e.g., an ingress tap point), a container that includes data regarding tap point T1e (e.g., an egress tap point), and a container that includes OCPM data (e.g., egress OCPM data) which may be connected to an on-board and/or in-system power balancing control loop. In some non-limiting embodiments, one or more of the containers (e.g., containers for data streams) can be accessed and/or transmitted over a communication connection, such as Ethernet, to an external session without interrupting the power balancing control loop. In some non-limiting embodiments, external sessions may display and/or process data fully independently. In some non-limiting embodiments, an external session may provide a whole band display, an OSNR measurement, streaming telemetry processing, data rate and/or modulation format identification for spectral service policing, valid channel confirmation and/or Loss of Signal (LoS) flag, center frequency measurement to monitor transmitter drift, signal fault isolation and signal diagnostics, and/or the like. In some non-limiting embodiments, a physical memory of the data structure that includes the plurality of containers can be implemented at various locations, including line card/sled hosting OCM, a chassis system controller, a high processing capable OCM, and/or the like. In some non-limiting embodiments, external sessions (e.g., external sessions outside of a power balancing control loop) may process data from different containers and/or the same containers.

In some non-limiting embodiments, data management system 102 may provide access to the data structure that includes the containerized data for one or more access devices 406. In some non-limiting embodiments, access device 406 may include a circuit, a controller, a computing device (e.g., a server, a group of servers, etc.), and/or other like devices, and allow for one or more application (e.g., software application) sessions of access device 406 (e.g., in the form of external processing sessions) to access the data structure of data repository 102a that includes the containerized data. In some non-limiting embodiments, data management system 102 may provide access to the data structure via a data stream. As further shown in FIG. 4B, data management system 102 may provide a data stream to a control system of an optical communications network via access device 406. In some non-limiting embodiments, data management system 102 may provide access to the containerized data in the data structure based on receiving a request from access device 406. For example, data management system 102 may receive a request from access device 406 that includes an identifier of a container of a plurality of containers of the data structure and data associated with access device 406 (e.g., a username, an identifier, a password, etc.). Data management system 102 may determine that access device 406 is authorized to access the container based on the data associated with access device 406, and data management system 102 may provide access to the container to access device 406 based on determining that access device 406 is authorized to access the container.

In some non-limiting embodiments, data management system 102 may provide access to the data structure for the one or more application sessions via a network connection, such as an Ethernet connection (e.g., a connection to an Ethernet bus), and/or a local connection, such as a local bus connection. In some non-limiting embodiments, data management system 102 may transmit containerized data to the one or more application sessions without interrupting a power balancing control loop. In some non-limiting embodiments, data management system 102 may provide a power balancing command to WSS 404-1 and/or WSS 404-2 as part of a power balancing control loop based on control loop data.

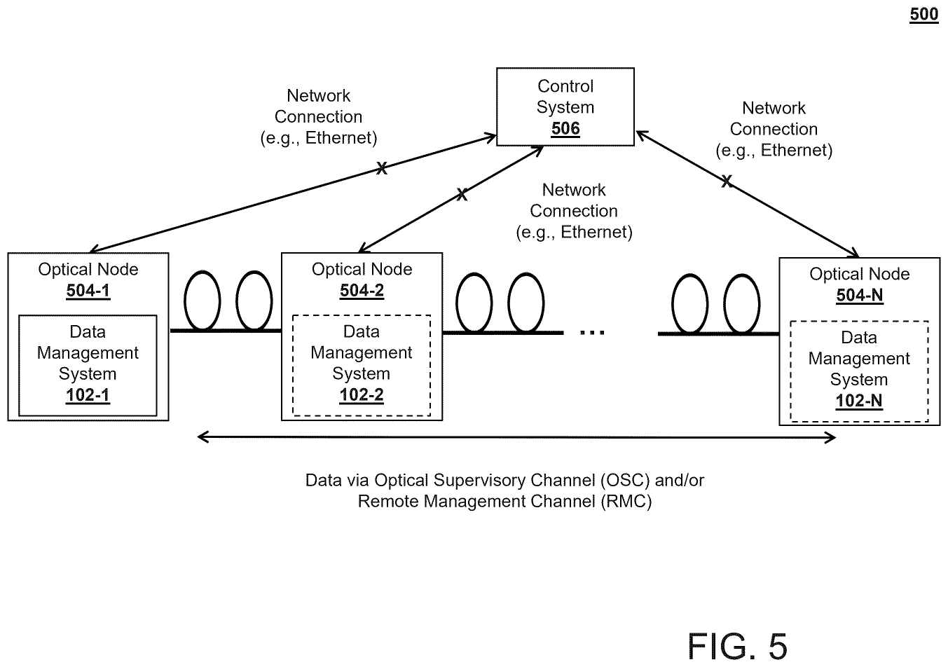

Referring now to FIG. 5, FIG. 5 is a diagram of an exemplary implementation 500 of a network of ROADM nodes. As shown in FIG. 5, a plurality of optical nodes 504-1 through 504-N (referred to individually as optical node 504 or collectively as optical nodes 504, as appropriate) are connected together via an optical network (e.g., an optical communications network that includes optical fibers) and are connected to a control system 506 via a network connection, such as an Ethernet connection. As further shown in FIG. 5, optical nodes 504 may include data management system 102-1 through data management system 102-N (referred to individually as data management system 102 or collectively as data management systems 102, as appropriate). In some non-limiting embodiments, control system 506 may include a network management system (NMS) and/or a software defined networking (SDN) controller.

During normal operation, data associated with each optical node 504 may be accessible by control system 506 through the respective network connection. However, in an event where the network connection is unavailable (e.g., the network connection is down, partially connected, and/or not setup during initial network installation) data (e.g., an OCM data stream) from different nodes can be transported through an Optical Supervisory Channel (OSC) and/or a Remote Management Channel (RMC) and accessible remotely by an external session from optical nodes 504 without the network connection.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A system, comprising:
at least one processor configured to:
receive data associated with an optical communications network;
containerize the data associated with the optical communications network according to a characteristic of the data to provide a data structure that includes containerized data; and
provide access to the data structure for one or more application sessions.

2. The system of claim 1, wherein the at least one processor is further configured to:
provide a power balancing command to a wavelength selective switch (WSS).

3. The system of claim 1, wherein the at least one processor is further configured to:
store the data structure in an on-board memory location of an optical channel monitoring (OCM) device.

4. The system of claim 1, wherein, when containerizing the data associated with the optical communications network according to a characteristic of the data, the at least one processor is configured to:
determine a first tap point associated with a first portion of the data associated with the optical communications network;
determine a second tap point associated with a second portion of the data associated with the optical communications network;
store the first portion of the data associated with the optical communications network in a first location of the data structure associated with the first tap point; and
store the second portion of the data associated with the optical communications network in a second location of the data structure associated with the second tap point.

5. The system of claim 1, wherein, when providing access to the data structure for the one or more application sessions, the at least one processor is configured to:
provide access to the data structure for the one or more application sessions via an Ethernet Bus.

6. The system of claim 1, wherein, when receiving the data associated with the optical communications network, the at least one processor is configured to:
receive the data associated with the optical communications network through at least one of the following:
an optical supervisory channel (OSC);
a remote management channel (RMC); or
any combination thereof.

7. The system of claim 1, wherein the at least one processor is further configured to:
transmit the containerized data to the one or more application sessions without interrupting a power balancing control loop.

8. A method, comprising:
receiving, with at least one processor, data associated with an optical communications network;
containerizing, with at least one processor, the data associated with the optical communications network according to a characteristic of the data to provide a data structure that includes containerized data; and
providing, with at least one processor, access to the data structure for one or more application sessions.

9. The method of claim 8, further comprising:
providing a power balancing command to a wavelength selective switch (WSS).

10. The method of claim 8, further comprising:
storing the data structure in an on-board memory location of an optical channel monitoring (OCM) device.

11. The method of claim 8, wherein containerizing the data associated with the optical communications network according to a characteristic of the data comprises:
determining a first tap point associated with a first portion of the data associated with the optical communications network;
determining a second tap point associated with a second portion of the data associated with the optical communications network;
storing the first portion of the data associated with the optical communications network in a first location of the data structure associated with the first tap point; and
storing the second portion of the data associated with the optical communications network in a second location of the data structure associated with the second tap point.

12. The method of claim 8, wherein providing access to the data structure for the one or more application sessions comprises:
providing access to the data structure for the one or more application sessions via an Ethernet Bus.

13. The method of claim 8, wherein receiving the data associated with the optical communications network comprises:
receiving the data associated with the optical communications network through at least one of the following:
an optical supervisory channel (OSC);
a remote management channel (RMC); or
any combination thereof.

14. The method of claim 8, further comprising:
transmitting the containerized data to the one or more application sessions without interrupting a power balancing control loop.

15. A computer program product, comprising at least one non-transitory computer-readable medium including one or more instructions that, when executed by at least one processor, cause the at least one processor to:
receive data associated with an optical communications network;
containerize the data associated with the optical communications network according to a characteristic of the data to provide a data structure that includes containerized data; and
provide access to the data structure for one or more application sessions; and
transmit the containerized data to the one or more application sessions without interrupting a power balancing control loop.

16. The computer program product of claim 15, wherein the one or more instructions further cause the at least one processor to:
provide a power balancing command to a wavelength selective switch (WSS).

17. The computer program product of claim 15, wherein the one or more instructions further cause the at least one processor to:
store the data structure in an on-board memory location of an optical channel monitoring (OCM) device.

18. The computer program product of claim 15, wherein, the one or more instructions that cause the at least one processor to containerize the data associated with the optical communications network according to a characteristic of the data, cause the at least one processor to:
determine a first tap point associated with a first portion of the data associated with the optical communications network;
determine a second tap point associated with a second portion of the data associated with the optical communications network;
store the first portion of the data associated with the optical communications network in a first location of the data structure associated with the first tap point; and
store the second portion of the data associated with the optical communications network in a second location of the data structure associated with the second tap point.

19. The computer program product of claim 15, wherein, the one or more instructions that cause the at least one processor to provide access to the data structure for the one or more application sessions, cause the at least one processor to:
provide access to the data structure for the one or more application sessions via an Ethernet Bus.

20. The computer program product of claim 15, wherein, the one or more instructions that cause the at least one processor to receive the data associated with the optical communications network, cause the at least one processor to:
receive the data associated with the optical communications network through at least one of the following:
an optical supervisory channel (OSC);
a remote management channel (RMC); or
any combination thereof.
